(19) United States
(12) Patent Application Publication
(10) Pub. No.: US 2025/0187441 A1
(43) Pub. Date: Jun. 12, 2025

(54) VIDEO DISPLAY DEVICE

(71) Applicants: TOYOTA JIDOSHA KABUSHIKI KAISHA, Aichi (JP); DENSO CORPORATION, Aichi (JP)

(72) Inventor: Masashi YAMAZAKI, Miyoshi-shi (JP)

(21) Appl. No.: 18/976,138

(22) Filed: Dec. 10, 2024

(30) Foreign Application Priority Data
Dec. 11, 2023 (JP) 2023-208293

(51) Int. Cl. B60K 35/81; B60K 35/28; B60R 1/23

(52) U.S. Cl. CPC B60K 35/81; B60K 35/28; B60R 1/23; B60K 2360/176; B60K 2360/21; B60R 2300/301; B60R 2300/60; B60R 2300/8093

(57) ABSTRACT

A video display device includes a camera with a wide-angle lens that captures a two-dimensional wide-angle video around a vehicle, a sensor that measures the distance to objects in the real space around the vehicle, a controller connected to the camera and the sensor, and a display device that displays images based on signals output from the controller. The controller calculates the position of the object in the wide-angle video captured by the camera based on the distance to the object in the real space measured by the sensor and corrects the distortion of the wide-angle video so that the calculated position of the object in the wide-angle video becomes horizontal on the screen of the display device.

### CROSS-REFERENCE TO RELATED APPLICATIONS

This application is based upon and claims the benefit of priority from Japanese Patent Application No. 2023-208293, filed on Dec. 11, 2023, the entire contents of which are incorporated herein by reference.

### TECHNICAL FIELD

The present disclosure relates to a video display device.

### BACKGROUND

Japanese Patent Application Publication No. 2010-003014 discloses a device for displaying images around a vehicle. This device includes a camera with a wide-angle lens mounted on the corner or license plate of the vehicle, a processing unit that corrects the distortion of the video captured by the camera, and a display that shows the corrected video.

### SUMMARY

The device described in Japanese Patent Application Publication No. 2010-003014 may cause notable objects to appear distorted. The correction of video distortion is achieved by stretching the image area around a predetermined position so that the predetermined position on the image becomes horizontal. Therefore, when a notable object is displayed at a position other than the predetermined position, the object may appear distorted. The present disclosure provides a technique that can appropriately display objects.

A video display device according to one embodiment of the present disclosure includes a camera with a wide-angle lens that captures a two-dimensional wide-angle video around a vehicle, a sensor that measures the distance to objects in the real space around the vehicle, a controller connected to the camera and the sensor, and a display device that displays images based on signals output from the controller. The controller calculates the position of the object in the wide-angle video captured by the camera based on the distance to the object in the real space measured by the sensor and corrects the distortion of the wide-angle video so that the calculated position of the object in the wide-angle video becomes horizontal on the screen of the display device.

According to the present disclosure, a technique is provided that can appropriately display objects.

### BRIEF DESCRIPTION OF THE DRAWINGS

FIG. 1 is a block diagram showing an example of the configuration of a vehicle equipped with a video display device according to one embodiment.

FIG. 2 is an example showing the situation in real space.

FIG. 3 is an example of a screen displaying a wide-angle video corrected based on a predetermined position.

FIG. 4 is an example of a screen displaying a wide-angle video corrected based on the position of an object.

FIG. 5 is a flowchart showing the operation of the video display device.

### DETAILED DESCRIPTION

Hereinafter, embodiments of the present disclosure will be described with reference to the drawings.

### Configuration of the Vehicle

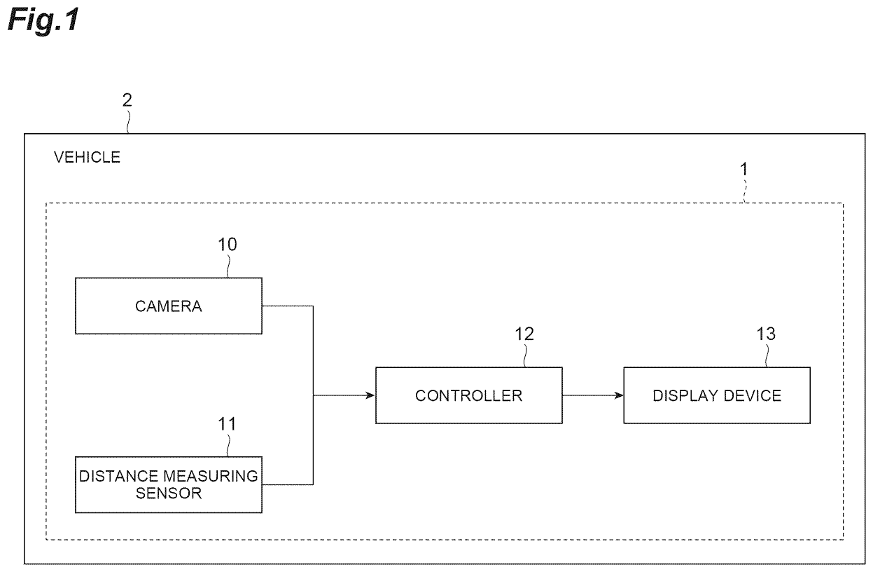

FIG. 1 is a block diagram showing an example of the configuration of a vehicle equipped with a video display device according to one embodiment. As shown in FIG. 1, the video display device 1 is mounted on a vehicle 2 as an example. The vehicle 2 may be a vehicle driven by a driver or an autonomous vehicle. The video display device 1 may be used, for example, for parking assistance or for checking traffic at an intersection with poor visibility by extending the front end of the vehicle 2 into the intersection.

The vehicle 2 includes a camera 10, a distance measuring sensor 11, a controller 12, and a display device 13.

The camera 10 is a camera that captures the surroundings of the vehicle 2. The camera 10 is provided at the front of the vehicle 2 as an example. The camera 10 may also be provided at the rear of the vehicle 2. The camera 10 has a wide-angle lens and captures a two-dimensional wide-angle video around the vehicle 2. The wide-angle lens is a lens with a field of view of about 60° or more, including a fisheye lens. The wide-angle video may be a moving image or a still image. The wide-angle video includes distortion corresponding to the wide-angle lens.

The distance measuring sensor 11 is a sensor that measures the distance to objects in the real space around the vehicle 2. The distance measuring sensor 11 may be a sensor using Lidar, a sensor using millimeter waves, a sensor using ultrasound, or a stereo camera.

The controller 12 has a function of managing the video display device 1. The controller 12 is configured as an ECU (Electronic Control Unit) as an example. The ECU is an electronic control unit including a CPU (Central Processing Unit), ROM (Read Only Memory), RAM (Random Access Memory), and a CAN (Controller Area Network) communication circuit. The controller 12 corrects the wide-angle video captured by the camera 10 and displays the corrected wide-angle video on the screen of the display device 13. The display device 13 is a device that displays images based on signals output from the controller 12, such as a display.

The controller 12 is connected to the camera 10 and the distance measuring sensor 11. The controller 12 acquires the wide-angle video from the camera 10 and determines whether an object exists around the vehicle 2 based on the measurement results of the distance measuring sensor 11. When an object exists around the vehicle 2, the controller 12 calculates the position of the object in the wide-angle video captured by the camera 10 based on the distance to the object in the real space. As a specific example, the controller 12 calculates the coordinate point of the object on the two-dimensional wide-angle video based on the relationship between the measured distance to the object in the real space and the field of view of the camera 10. This allows the controller 12 to calculate the position of the object in the distorted two-dimensional wide-angle video. The controller 12 may also learn the appearance of the object due to the distortion of the wide-angle video of the camera 10 and directly acquire the position of the object from the camera 10. The “video” means not only moving images but also still images.

The controller 12 corrects the distortion of the wide-angle video so that the position of the object in the two-dimensional wide-angle video becomes horizontal on the screen of the display device 13. The technique for making the reference position of the wide-angle video horizontal can adopt known techniques.

When no object exists around the vehicle 2, the controller 12 corrects the distortion of the wide-angle video so that a predetermined position in the wide-angle video becomes horizontal on the screen of the display device 13. The predetermined position may be the position of the optical axis or the center of the image.

### Example of Distortion Correction of Wide-Angle Video

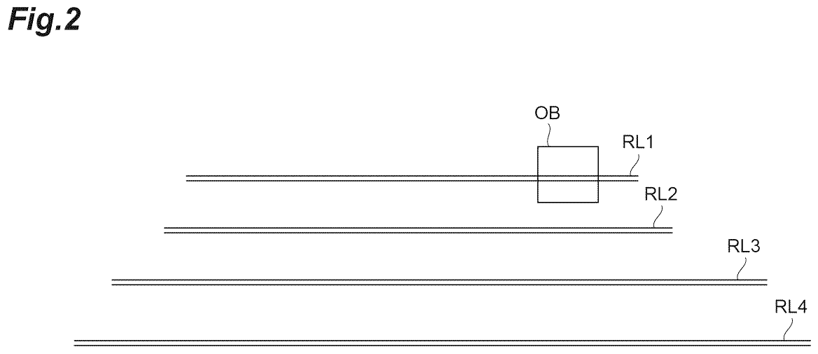

FIG. 2 is an example showing the situation in real space. In the example shown in FIG. 2, four lines and an object OB exist as the imaging targets in front of the vehicle 2. The four lines are, in order from back to front, the first line RL1, the second line RL2, the third line RL3, and the fourth line RL4. An example of the four lines is lane boundary lines. The object OB is a moving object as an example, and more specifically, a vehicle. The object OB is positioned to appear overlapping with the first line RL1. In the example shown in FIG. 2, four lines and one object are shown to easily illustrate the distortion of the image, but the imaging targets are not limited to these.

First, an overview of the situation where the object OB shown in FIG. 2 does not exist is provided. In other words, it is a situation where the four lines are the imaging targets. In this situation, the controller 12 corrects the distortion of the wide-angle video so that a predetermined position in the wide-angle video becomes horizontal on the screen of the display device 13. As an example, the predetermined position is the position where the third line RL3 is displayed.

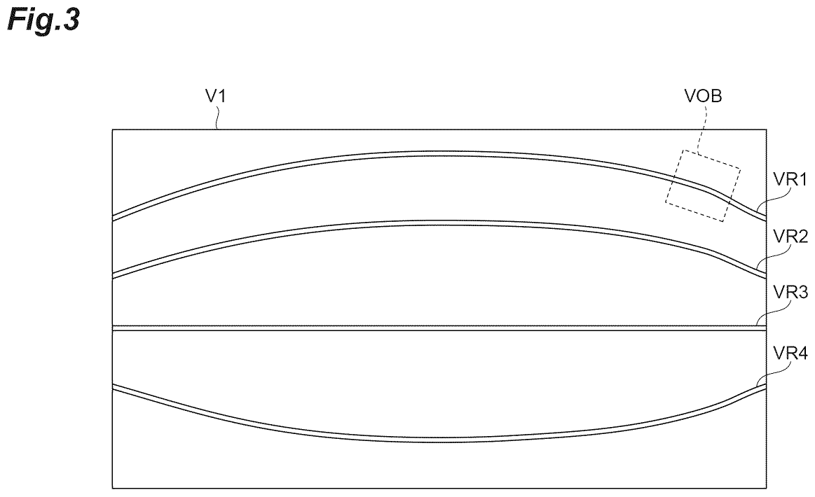

FIG. 3 is an example of a screen displaying a wide-angle video corrected based on a predetermined position. In the screen V1 shown in FIG. 3, the position of the third line image VR3 corresponding to the third line RL3 is displayed to be horizontal on the screen V1. This makes the third line image VR3 displayed as a straight line. The first line RL1 and the second line RL2 are located further back than the third line RL3. Therefore, the corresponding first line image VR1 and second line image VR2 are displayed above the third line image VR3 on the screen V1. However, since the image area above the third line image VR3 is stretched to make the third line image VR3 straight, it will be distorted in a shape that is pulled upward. Therefore, the first line image VR1 and the second line image VR2 will not be straight and will be curved line images that bulge upward. The fourth line RL4 is located in front of the third line RL3. Therefore, the corresponding fourth line image VR4 is displayed below the third line image VR3. However, since the image area below the third line image VR3 is stretched to make the third line image VR3 straight, it will be distorted in a shape that is pulled downward. Therefore, the fourth line image VR4 will not be straight and will be a curved line image that bulges downward.

The screen V1 shown in FIG. 3 is a suitable image when the third line RL3 is to be detected. However, in traffic situations, it is required to accurately grasp and respond to obstacles, especially moving objects. Since the object OB shown in FIG. 2 is located near the first line RL1, when the position of the third line image VR3 is corrected to be horizontal on the screen V1, as shown by the dashed line in FIG. 3, the object image VOB will be displayed with a large curvature. Furthermore, since the object image VOB will move along the first line image VR1, it will appear to be turning. Therefore, it becomes difficult to calculate the movement of the object OB from the object image VOB.

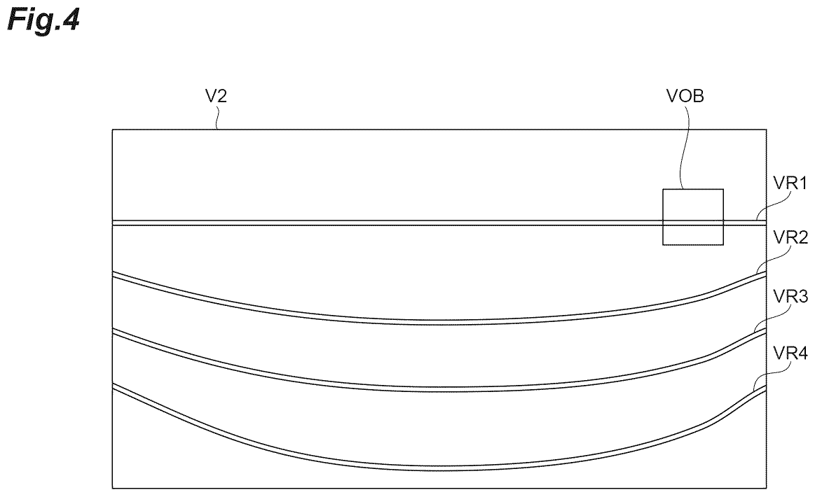

Therefore, when an object exists around the vehicle 2, the controller 12 corrects the distortion of the wide-angle video so that the position of the object in the wide-angle video (the position of the object image VOB) becomes horizontal on the screen of the display device 13. This makes the first line image VR1 straight on the screen V2, as shown in FIG. 4, and the object image VOB is also displayed without distortion. This makes the movement of the object image VOB the same as the movement of the object OB, allowing the calculation of the movement of the object OB from the object image VOB.

### Operation of the Video Display Device

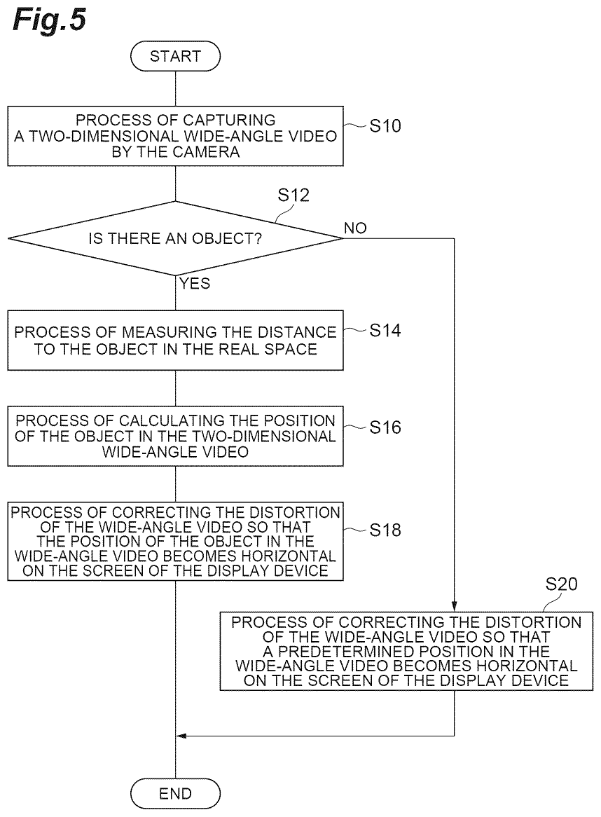

FIG. 5 is a flowchart showing the operation of the video display device. The flowchart shown in FIG. 5 is executed by the video display device 1, for example, at the timing when a driver operation is received.

As shown in FIG. 5, first, the camera in the video display device 1 captures a two-dimensional wide-angle video as STEP S10. Next, the controller 12 of the video display device 1 determines whether an object OB exists around the vehicle 2 as STEP S12. The controller 12 may determine the existence of the object OB based on the detection result of the distance measuring sensor 11, for example.

When it is determined that the object OB exists (STEP S12: YES), the controller 12 measures the distance to the object OB in the real space based on the detection result of the distance measuring sensor 11 as STEP S14.

Next, the controller 12 calculates the position of the object OB in the two-dimensional wide-angle video as STEP S16. The controller 12 calculates the position of the object OB based on the detection result of the distance measuring sensor 11. Next, the controller 12 corrects the distortion of the wide-angle video so that the position of the object in the wide-angle video (the position of the object image VOB) becomes horizontal on the screen of the display device 13 as STEP S18 (see FIG. 4, for example).

When it is determined that the object OB does not exist in STEP S12 (STEP S12: NO), the controller 12 corrects the distortion of the wide-angle video so that a predetermined position in the wide-angle video becomes horizontal on the screen of the display device 13 as STEP S20 (see FIG. 3, for example).

When STEP S18 or STEP S20 ends, the flowchart shown in FIG. 5 ends. When the flowchart shown in FIG. 5 ends, the video display device 1 repeats the flowchart shown in FIG. 5 from the beginning unless an end condition such as receiving a driver operation to end the process is met.

### SUMMARY OF THE EMBODIMENT

In the video display device 1, the position of the object in the wide-angle video captured by the camera 10 is calculated, and the distortion of the wide-angle video is corrected so that the calculated position of the object in the wide-angle video becomes horizontal on the screen of the display device 13. This allows the video display device 1 to mitigate the distortion of notable objects, thereby appropriately displaying the objects.

While exemplary embodiments have been described, various omissions, substitutions, and changes may be made without departing from the spirit of the disclosure.

What is claimed is:

1. A video display device comprising:
a camera with a wide-angle lens configured to capture a two-dimensional wide-angle video around a vehicle;
a sensor configured to measure a distance to an object in a real space around the vehicle;
a controller connected to the camera and the sensor; and
a display device configured to display video based on signals output from the controller,
wherein the controller calculates a position of the object in the wide-angle video captured by the camera based on the distance to the object in the real space measured by the sensor and corrects a distortion of the wide-angle video so that the calculated position of the object in the wide-angle video becomes horizontal on a screen of the display device.

2. The video display device according to claim 1, wherein the controller determines whether the object exists around the vehicle and corrects the distortion of the wide-angle video so that a predetermined position in the wide-angle video becomes horizontal on the screen of the display device when the object does not exist around the vehicle.
